(19) United States
(12) Patent Application Publication
(10) Pub. No.: US 2009/0022154 A1
(43) Pub. Date: Jan. 22, 2009

(54) RECEPTION DEVICE, RECEPTION METHOD, AND COMPUTER-READABLE MEDIUM

(76) Inventors: Masahiro KIRIBE, Kanagawa (JP); Yasushi Katayama, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/174,979

(22) Filed: Jul. 17, 2008

(30) Foreign Application Priority Data
Jul. 19, 2007 (JP) 2007-188181

(51) Int. Cl. H04L 12/56

(52) U.S. Cl. 370/390

(57) ABSTRACT

A reception device and method are provided for receiving content on channels distributed by distribution servers via a router. The method includes registering a multicast media access control address corresponding to a channel to be switched to before switching to the channel; storing the multicast media access control address; and switching to the channel using the stored multicast media access control address.

### CROSS REFERENCE

The present invention contains subject matter related to Japanese Patent Application JP 2007-188181, filed in the Japanese Patent Office on Jul. 19, 2007, the contents of which are incorporated herein by reference.

### TECHNICAL FIELD

The invention relates to a reception device, a reception method, and a computer-readable medium. Specifically, the invention relates to a reception device for receiving multicast distribution data and a reception method.

### BACKGROUND INFORMATION

With recent advances in network technology, programs (e.g., content) are distributed through networks. Providers that distribute programs convert the programs to Internet Protocol (IP) packets, and then distribute the programs from servers using multicast distribution, where the same signal is distributed to a plurality of recipients. The protocols generally used to receive the multicast distribution programs include Internet Group Management Protocol (IGMP) for Ipv4 network environments and Multicast Listener Discovery (MLD) for Ipv6 network environments.

When a multicast distribution program is received using IGMP or MLD, the reception device transmits a “join” message to receive the program. By issuing a join message, the reception device can join the multicast group and the program can be viewed. To end viewing of the program, a “leave” message is transmitted. By issuing a leave message, the reception device can leave the multicast group and end viewing of the program.

When distributing a program via a network, the reception device receiving the program must issue the join message and the leave message in order to switch channels and programs. Thus, the wait time required for channel switchover is generally longer than for television broadcasts and the like, which use normal radio waves. It is therefore desirable to realize high-speed program selection in the context of distribution of programs via a network.

One proposed solution to overcome the above problem and realize high-speed program selection on a network includes a method in which, for example, when switching channels, a request to start streaming the channel to be switched to (hereinafter referred to as the “next channel”) is issued before ending the streaming of the program currently being viewed (hereinafter referred to as the “previous channel”).

However, in this method, it is necessary to set, on the reception device receiving the program, a multicast media access control (MAC) address for the content being distributed by the distribution server when switching channels. The time required to set the multicast MAC address when switching channels, however, results in a channel switchover delay.

### SUMMARY

To address the above-discussed problems, embodiments of the present invention encompass methods, apparatuses, and computer readable media for registering multicast MAC addresses corresponding to content on channels being distributed by the content distribution servers in advance, allowing the time required for switching channels to be reduced.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

According to an embodiment, there is provided a reception device for receiving content on channels distributed by distribution servers via a router. The reception device may include a memory storing a physical address setting portion that registers a multicast media access control address of a channel to be switched to before switching the channel; a physical address memory portion that stores the multicast media access control address; and a channel switching portion that uses the stored multicast media access control address to switch to the channel. The reception device may further include a processor that executes the physical address setting portion, the physical address memory portion, and the channel switching portion.

According to another embodiment, there is provided a method for receiving, by a reception device, content on channels distributed by distribution servers via a router. The method may include registering a multicast media access control address corresponding to a channel to be switched to before switching to the channel; storing the multicast media access control address; and switching to the channel using the stored multicast media access control address.

According to another embodiment, there is provided a reception device for receiving content on channels distributed by distribution servers via a router. The reception device may include means for registering a multicast media access control address of a channel to be switched to before switching the channel; means for storing the multicast media access control address; and means for using the stored multicast media access control address to switch to the channel.

According to yet another embodiment, there is provided a computer-readable medium storing a computer program which, when executed by a computer, causes the computer to perform a method of receiving content on channels distributed by distribution servers via a router. The method may include registering a multicast media access control address corresponding to a channel to be switched to before switching to the channel; storing the multicast media access control address; and switching to the channel using the stored multicast media access control address.

According to the embodiments described above, the multicast media access control addresses for the channels being distributed by the distribution servers may be registered in advance, and the time required to switch channels can be reduced. Thus, a new and improved reception device, reception method, and computer program are provided that allow the time required to switch channels to be reduced.

### BRIEF DESCRIPTION OF THE DRAWINGS

FIG. 1 is an explanatory diagram illustrating a multicast distribution system 10 that uses a reception device 100 according to a first embodiment;

FIG. 2 is an explanatory diagram illustrating the reception device 100 according to the first embodiment;

FIG. 3 is an explanatory diagram illustrating channel switching of distributed content;

FIG. 4 is another explanatory diagram illustrating channel switching of distributed content;

FIG. 5 is an explanatory diagram illustrating channel switching for a receiver receiving the content;

FIG. 6 is an explanatory diagram illustrating delivery to the receiver of packets remaining in the RTP streaming network before channel selection;

FIG. 7 is an explanatory diagram illustrating channel switching in a receiver receiving content in a multicast network;

FIG. 8 is a sequence diagram illustrating the flow of channel switching for the reception device 100 according to the first embodiment;

FIG. 9 is a flow chart illustrating flow of channel switching for the reception device 100 according to the first embodiment;

FIG. 10A is an explanatory diagram illustrating a MAC address;

FIG. 10B is an explanatory diagram illustrating an IP multicast address and a multicast MAC address;

FIG. 11 is an explanatory diagram illustrating a multicast distribution system according to a second embodiment.

### DETAILED DESCRIPTION

Reference will now be made in detail to embodiments of the present invention, examples of which are illustrated in the accompanying drawings. Wherever possible, the same reference numbers will be used throughout the drawings to refer to the same or like parts, and repeated explanation of these parts is omitted.

First, a reception device according to a first embodiment, and a reception method using the reception device, will be explained.

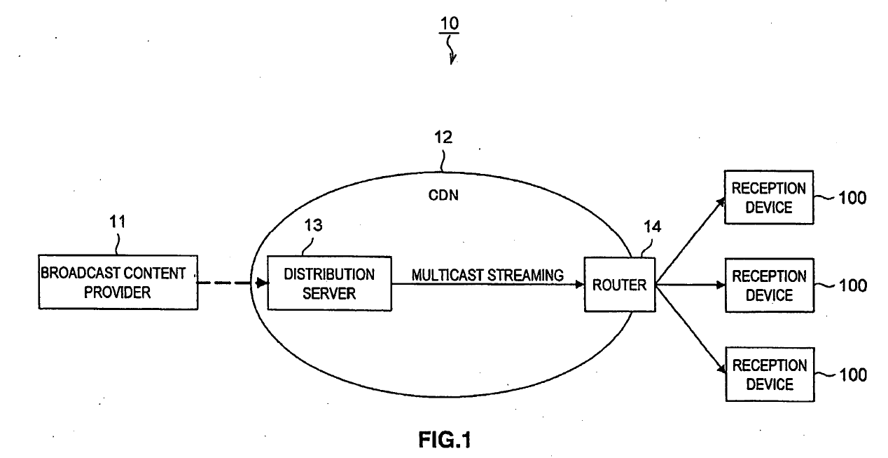

FIG. 1 is an explanatory diagram illustrating a multicast distribution system 10 using a reception device 100 according to the first embodiment.

As shown in FIG. 1, the multicast distribution system 10 may include a distribution server 13 that allows a broadcast content provider 11 to distribute content, and a router 14 that may receive the content and transmit the content to the destination reception device 100.

The distribution server 13 and the router 14 may be connected by a content delivery network (CDN) 12. The CDN 12 may be a network optimized to distribute digital content with a large file size via the network.

The distribution server 13 may control distribution of the multicast content data, such as Internet Protocol Television (IPTV) content and the like. The distribution server may also distribute image and voice media streams for the multicast content to the reception device 100, in response to requests from the reception device 100. The distribution server 13 may be a content provider server, such as an IPTV server, a broadcasting station, or the like.

The router 14 may be a device that relays data passing through the multicast distribution system 10. The function of the router 14 may be to forward the content transmitted from the distribution server 13 to the destination reception device 100, and to forward content requests from the reception device 100 to the distribution server 13.

In order to simplify the explanation, FIG. 1 shows one distribution server 13 and one router 14. It is to be appreciated, however, that multicast distribution system 10 may contain a plurality of distribution servers and routers.

The reception device 100 may be a device that receives and plays back content. The reception device 100 may have network communications functions and be compatible with multicast content. The reception device 100 may be, for example, a computer (e.g., a laptop or a desktop computer), such as a personal computer (PC), a television receiver, a cellular telephone, a personal digital assistant (PDA), a television broadcast tuner or decoder, or another suitable computing device.

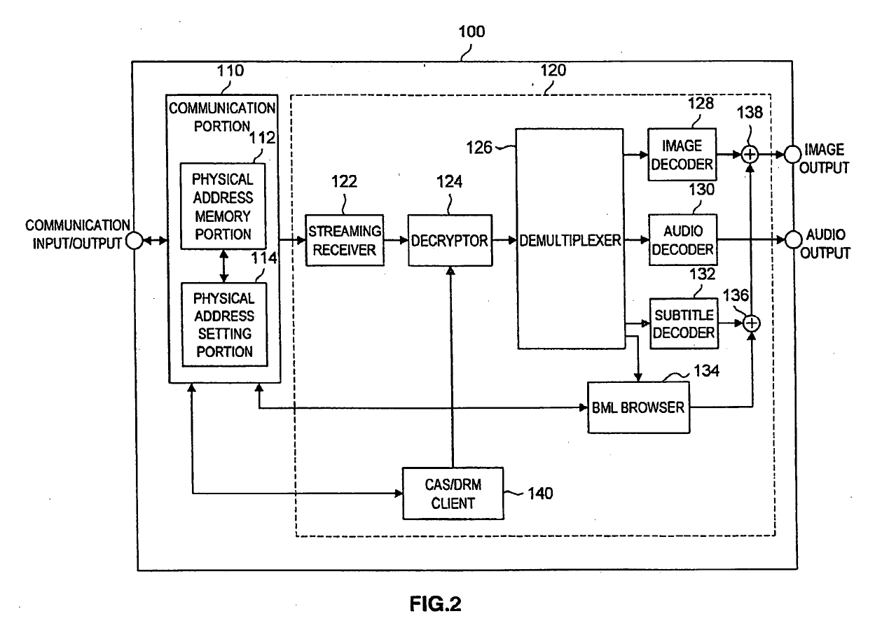

FIG. 2 is an explanatory diagram illustrating reception device 100 according to the first embodiment.

As shown in FIG. 2, the reception device 100 may include a communication portion 110 and a control portion 120. The communication portion 110 may include a physical address memory portion 112 and a physical address setting portion 114. The control portion 120 may include a streaming receiver 122, a decryptor 124, a demultiplexer 126, an image decoder 128, an audio decoder 130, a subtitle decoder 132, a BML (Broadcast Markup Language) browser 134, adders 136 and 138, and a CAS/DRM (conditional access system/digital rights management) client 140.

The communication portion 110 may receive the content distributed by the distribution server 13 via the CDN 12 and may transmit data sent from the reception device 100 to the distribution server 13. The communication portion 110 may be, for example, a network interface card (NIC) or another suitable communication device.

The communication portion 110 may be provided with the physical address memory portion 112 and the physical address setting portion 114. The physical address setting portion 114 may register or set a multicast MAC (Media Access Control) address corresponding to channels distributed by the distribution server 13 in advance of receiving the content on the channels from the distribution server 13. The physical address memory portion 112 may store the MAC address set by the physical address setting portion 114.

The control portion 120 may control all of the elements of the reception device 100. Specifically, the control portion 120 may control playback of the content received by the reception device 100. The streaming receiver 112 may receive the content distributed by the distribution server 13 via the communication portion 110.

The decryptor 124 decrypts the content received by the streaming receiver 112. When the content is decrypted by the decryptor 124, information necessary for the decryption is received from the CAS/DRM client 140. The information for decryption may be, for example, information to determine whether the received content can be played back on the reception device 100.

The demultiplexer 126 may separate the content decrypted by the decryptor 124 into image, audio, and subtitle data, respectively, and output the separated data. As the image, audio, and subtitle data of the content may be multiplexed before being distributed by the distribution server 13, the reception device 100 may require that the demultiplexer 126 separate the multiplexed data.

The image decoder 128 may input the image data separated by the demultiplexer 126, and then decode and output the input image data. Similarly, the audio decoder 130 may input the audio data separated by the demultiplexer 126, and then decode and output the input audio data. The subtitle decoder 132 may input the subtitle data separated by the demultiplexer 126, and then decode and output the input subtitle data.

The BML browser 134 may play back data marked up in broadcast markup language (BML) format. BML is an extensible markup language (XML)-based description language used for data broadcasting. Data marked up in the BML format may be input to the adder 136 and added to the subtitle data decoded by the subtitle decoder 132.

The adder 136 may add the subtitle data decoded by the subtitle decoder 132 and the data played back by the BML browser 134. Then, the adder 138 may add the output from the adder 136 to the image data decoded by the image decoder 128 and output the data through the image output. Likewise, the audio data decoded by the audio decoder 130 may be output through the audio output.

The CAS/DRM client 140 may control a conditional access system (CAS) and digital rights management (DRM). The CAS/DRM client 140 is one example of a channel-switching portion of the present invention. The CAS/DRM client 140 may determine, for example, whether the reception device 100 is authorized to play back the received content.

The CAS/DRM client 140 may instruct the communication portion 110 to switch the channel being received. When switching the channel being received, the CAS/DRM client 140 may instruct the communication portion 110 to issue a message requesting to receive the content on the channel to be switched to (i.e., the next channel). The timing of the channel switching instruction may be, for example, when a user issues an instruction to switch channels using a remote control or the like.

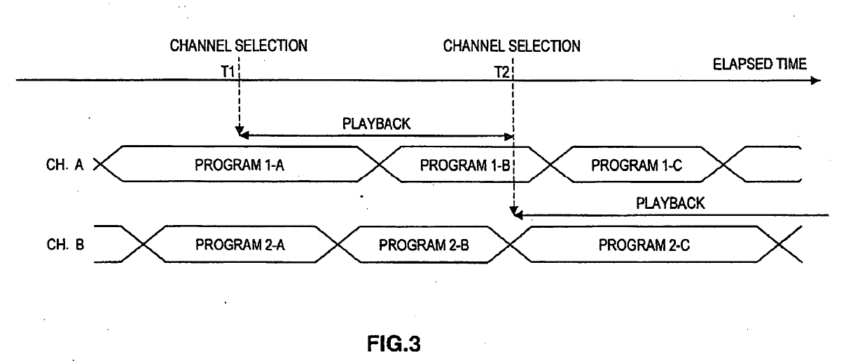

FIG. 3 is an explanatory diagram illustrating channel switching. In order to simplify the explanation, FIG. 3 illustrates the content of two (2) channels passing through the network.

At a point of elapsed time T1, a user wishing to view the content has selected channel A (Ch. A). At the point in time T1, channel A may be distributing a program 1-A, and the user can view the program 1-A on channel A.

As time elapses, the program 1-A being distributed by channel A may end, and program 1-B may be distributed by channel A. Then, at a point in time T2, the user may change from channel A to channel B (Ch. B). When the channel is changed, the user can view the program 2-C being distributed by channel B at the point in time T2.

The flow of setting channels that can be selected on a receiver receiving multicast content will now be explained.

The receiver receiving the multicast content may obtain an IP address during initialization. When the receiver receives the IP address, the receiver may obtain configuration information corresponding to a uniform resource identifier (URI) (unique, predetermined information). Then, depending on the presence or lack of data described in the configuration information, the receiver may determine whether the provider is providing an IP broadcast.

As the IP broadcast provider may have access to the multicast address information, etc., the IP broadcast provider may transmit a join message to join the multicast group of the SI multicast stream to an edge router in order to receive the service information (SI) for configuring the IP broadcast. The IP broadcast provider may then receive a multicast stream for the service and thereby obtain the relevant platform network information table (NIT).

After the above-described process, the receiver may refer to service list descriptors marked up contained in the NIT or the BIT (Broadcaster Information Table) and IP distribution system descriptors contained in the NIT for channel selection. The receiver may then create, in advance, a channel selection list that takes into consideration service contracts, promotional channels, and the like.

When the receiver receives a channel selection input (e.g., a channel number selection) from a remote control or the like, the receiver may determine whether the channel is included on the channel selection list. If it is determined that the channel is included on the channel selection list, the multicast MAC address corresponding to the channel may be set on the receiver network interface card (NIC) filter and, at the same time, a multicast group join message may be transmitted to the edge router. The multicast stream for the channel can then be received.

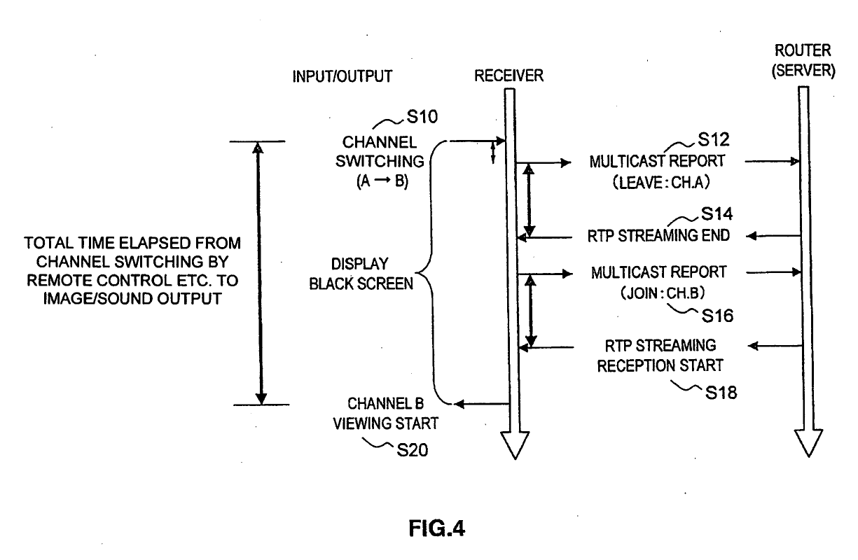

FIG. 4 is an explanatory diagram illustrating channel switching for distributed content in a multicast network. As in FIG. 3, when switching from channel A to channel B, a command to switch the channel may be issued to the receiver receiving the content (step S10). The command issued to the receiver may be, for example, a channel selection command (e.g., a channel number selection) from a remote control.

When the receiver receives a channel selection command, the receiver may transmit a leave multicast report to a router (or a server) to leave channel A (step S12).

When the router (or the server) receives the multicast report from the receiver to leave channel A, the router (or the server) may end the real time transport stream (RTP stream) distributing the content of channel A (step S14). RTP is a communication protocol in which packets include time information, and is used to forward data in real time.

When the RTP stream is ended by the server, the receiver may subsequently issue a multicast report to the router (or the server) to join channel B (step S16). When the router (or the server) receives the multicast message from the receiver to join channel B, the router (or the server) may start an RTP stream for distributing the content on channel B (step S18). By receiving the RTP stream for channel B, the receiver can play back the content on channel B.

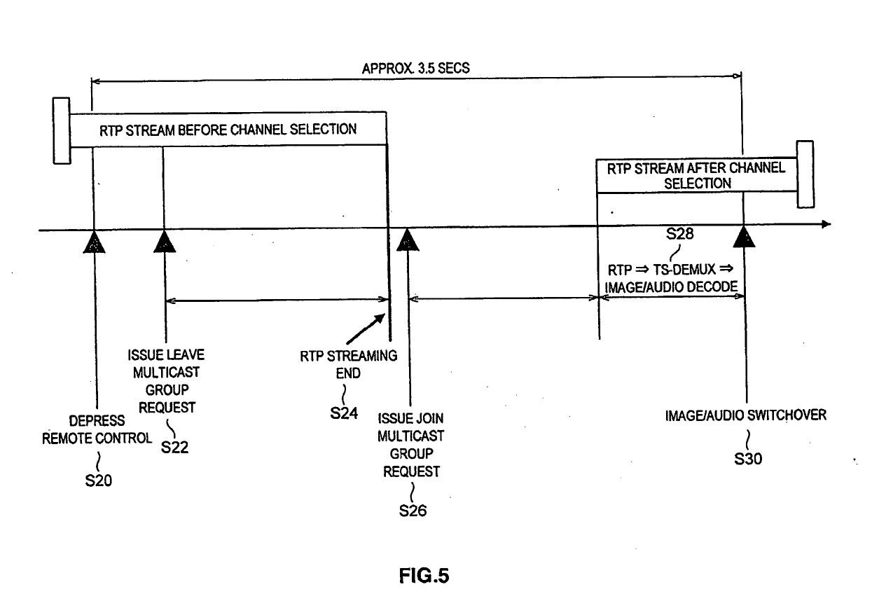

FIG. 5 is an explanatory diagram illustrating the switching of channels on a receiver receiving content distributed in a multicast network. In the example shown in FIG. 5, a remote control may be used to switch the channels of the receiver.

First, the user may provide input to the remote control to instruct the receiver to switch channels (e.g., a channel number selection) (step S20). When the receiver receives the instruction to switch channels, the receiver may issue a request to a router (or a server) to leave the multicast group supported by the server distributing the content (step S22).

When the server receives a direct request from the receiver or a request from the receiver via the router to leave the multicast group, the server may end the RTP stream for the content on the channel being received up to that time (step S24). When the RTP stream ends, the receiver may issue a request to the server to join another multicast group to receive the content of the next channel (step S26).

When the server receives the multicast group join request, the relevant multicast group RTP stream may be transmitted to the receiver by multicast distribution. When the receiver receives the RTP stream, the receiver may separate the received stream into image, audio, and subtitle data, respectively, and decode the separated data (step S28). The decoded data may then be output, completing the image/audio switchover (step S30).

In this manner, in the distribution of content using a multicast network, when the channel is switched on the receiver, the next process is started only after the completion of each previous process is confirmed, and the time required to complete the channel switching (image/audio switchover) may therefore be relatively long.

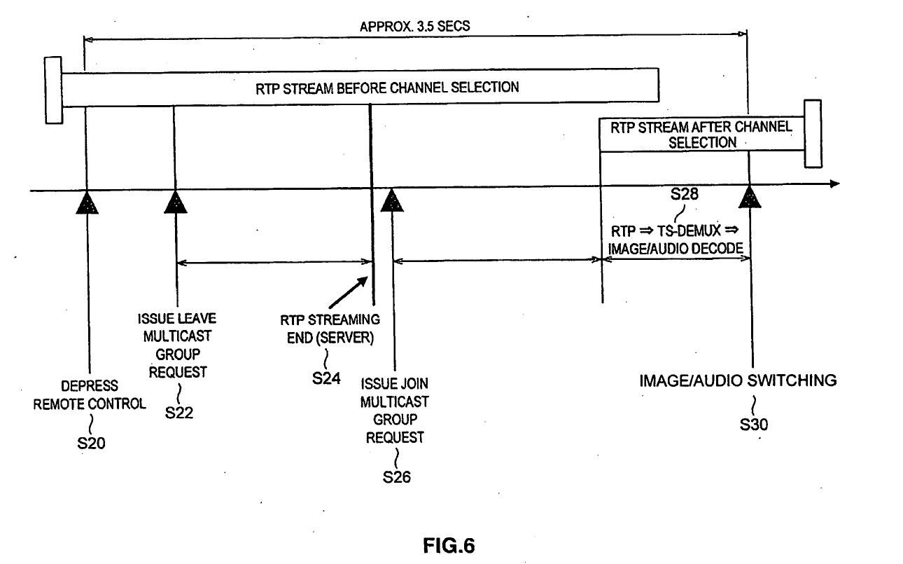

Referring to FIG. 5, in step S24, at the point at which the server ends the RTP stream, the RTP stream distributed before the channel selection is ended. However, in actuality, even when the server ends this RTP stream, for a short time, packets remaining in the network for the RTP stream may continue to reach the receiver. FIG. 6 is an explanatory diagram illustrating the delivery to the receiver of the packets in the RTP stream remaining in the network before channel selection.

As shown in FIG. 6, in known content distribution systems using a multicast network, the time required to switch channels in the receiver may be approximately 3.5 seconds. The time required to switch channels in the receiver is mainly due to the issuing by the receiver of the multicast group join and leave requests, the setting of the multicast MAC address corresponding to the content on the channel being distributed by the distribution server on the NIC filter, and the coming and going of packets between the receiver and the server.

As of 2007, the time required to switch channels during digital terrestrial broadcasting may be just over two seconds. It is therefore desirable for the time required to change channels in a receiver receiving content distributed using a multicast network to be no more than 1 second longer than the time required to switch channels during digital terrestrial broadcasting.

In the above-described known channel switching, the receiver may wait for the RTP stream from the server for the previous channel to end, and then issue a request to join the multicast group for the next channel. However, the request to join the multicast group for the next channel may be issued before the RTP stream for the previous channel ends.

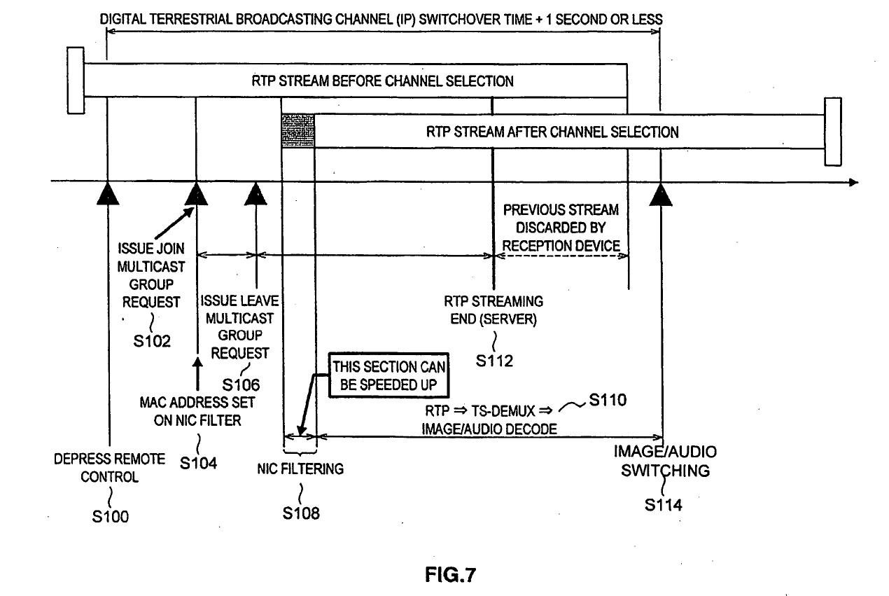

FIG. 7 is an explanatory diagram illustrating channel switchover on a receiver receiving content distributed in a multicast network. FIG. 7 illustrates the switching of channels where the request to join the multicast group for the next channel is issued before the RTP stream for the previous channel ends.

In this case also, the user may first provide input to the remote control to instruct the receiver to switch the channel (step S100). When the receiver receives the instruction to switch channels, the receiver may issue a request to the server distributing the content to request to join the next multicast group (step S102).

At this time, the multicast MAC address corresponding to the multicast group for content on the next channel may be set on the receiver network interface card (NIC) filter (step S104). By setting the multicast MAC address corresponding to the content on the next channel, the distribution server may determine whether the multicast packets are addressed to the server.

Next, the receiver may issue a request to the server to leave the multicast group for the previous channel (step S106). When the server receives this request from the receiver, the server may distribute the RTP stream by multicast to the receiver for the next multicast group. When the receiver receives the RTP stream, the receiver may use the multicast MAC address corresponding to the multicast group for the next channel, which is registered on the NIC filter, to perform filtering on the packets received and to verify that the packets are addressed to the receiver (step S108).

If, as a result of filtering, it is determined that the received packets are addressed to the receiver, the RTP stream may be received, the received stream may be separated into image, audio, and subtitle data, and the separated data may be decoded (step S110). Then, the server may end the RTP stream for the content on the previous channel (step S112). Even when the server ends the RTP stream for the previous channel, for a short time, packets remaining in the network for the RTP stream for the previous channel may be delivered to the receiver. However, these packets may be discarded by the receiver.

The output of the decoded data may complete the image/audio switchover (step S114).

In the present embodiment, when switching channels, the setting of the multicast MAC address on the NIC filter, as described in step S104 above, may be performed in advance of switching the channel. By setting the multicast MAC address for the next channel on the NIC filter before switching channels, the packet filtering process by the NIC filter described in step S108 above can be shortened, and the time required to switch channels can be reduced.

In the present embodiment, the physical address setting portion 114 may set multicast MAC addresses corresponding to the content on a channel being distributed by a content distribution server. The multicast MAC addresses may be set for predetermined selected channels to decrease the time required to switch channels. The set multicast MAC addresses may be stored in the physical address memory portion 112.

A list of predetermined channels may be selected to reduce the time required to switch channels. For example, the list of predetermined channels may be a key station system list; a channel list based on the key station system list (e.g., digital terrestrial broadcasts, BS digital broadcasts, or a combination thereof); a pay-TV system channel list (e.g., channels subscribed to by a viewer, channels recommended by a provider, or a combination thereof); a list combining key station system (e.g., digital terrestrial broadcasts or BS digital broadcasts) and pay-TV system channels (i.e., preferred channels registered in advance by a user); and/or a list of regularly-viewed channels (e.g., recently viewed channels within a maximum number of channels that can be set on the NIC filter, or a fixed number of selected channels).

As the multicast MAC addresses for channels in the predetermined list of channels are stored in the reception device 100, it may be unnecessary to set the multicast MAC address corresponding to the newly selected channel when switching channels (because the multicast MAC address may already be stored in the predetermined list of channels). Thus, quicker channel switching may be provided.

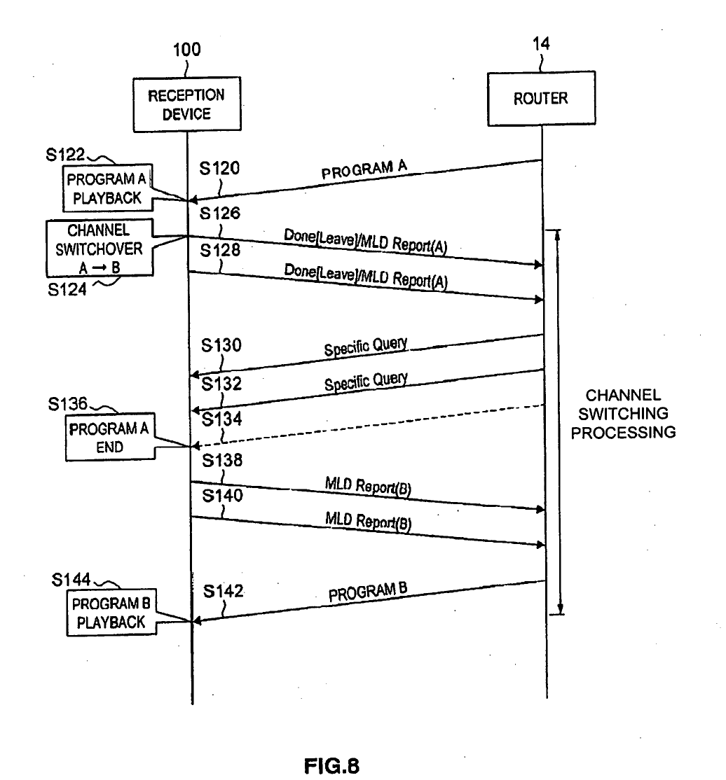

FIG. 8 is a sequence diagram illustrating the flow of channel switching for content distributed using a multicast network for the reception device 100 according to the first embodiment. In FIG. 8, the flow of data exchanged between the router 14 and the reception device 100 is used to explain channel switchover. In this example, the flow is explained with respect to switching between channel A and channel B.

First, a program 1-A on channel A may be multicast from the distribution server 13 via the router 14 (step S120). The reception device 100 may play back the received program 1-A (step S122). The content of the received program can be viewed by the user on the reception device 100 as described above. Namely, the program may be played back after being received by the streaming receiver 122, decrypted by the decryptor 124, and separated by the demultiplexer 126. Then, the separated data may be decoded by the image decoder 128, the audio decoder 130, and the subtitle decoder 132.

The user viewing the content on the reception device 100 may switch from channel A to channel B (step S124). When the switching is performed, the reception device 100 may issue multicast reports to the router 14 via the communications portion 110 to leave channel A (steps S126 and S128). The two multicast reports issued in step S126 and step S128 may be issued in compliance with standard regulations.

When the distribution server 13 receives the multicast reports from the reception device 100 via the router 14, the distribution server 13 may transmit specific queries to the reception device 100 (steps S130 and S132). The two specific queries may be issued in compliance with standard regulations.

After issuing the queries, the distribution server 13 may end the RTP stream for program 1-A being distributed on channel A (step S134). When the RTP stream is ended, the program 1-A being played back by the reception device 100 may end (step S136).

Next, in order to receive the content on channel B, the reception device 100 may issue multicast reports to the distribution server 13 distributing channel B to join channel B (steps S138 and S140). The two multicast reports may be issued in compliance with standard regulations.

The multicast MAC address for channel B may be stored in the physical address memory portion 112 in advance of the issuing of the multicast reports to join channel B. By storing the multicast MAC address for channel B in advance, the time required for switching to channel B can be reduced.

When the distribution server 13 receives the request from the reception device 100 to join channel B, the distribution server 13 may distribute channel B, carrying program 1-B, to the reception device 100 by multicast distribution (step S142). When the reception device 100 receives program 1-B on channel B, the content of program 1-B can be viewed by the user on the reception device 100 as described above. Namely, the program may be played back after being received by the streaming receiver 122, decrypted by the decryptor 124, and separated by the demultiplexer 126. The separated data may then be decoded by the image decoder 128, the audio decoder 130, and the subtitle decoder 132 (step S144).

In FIG. 8, the reception device 100 may issue a request to the distribution server 13 to join channel B after issuing the request to leave channel A. It is to be appreciated, however, that the request to join channel B may be issued before the request to leave channel A. Also, in FIG. 8, the request to join channel B may be issued after the distribution server 13 ends the distribution of channel A. It is to be appreciated however, that the request to join channel B may be performed before the distribution of channel A ends.

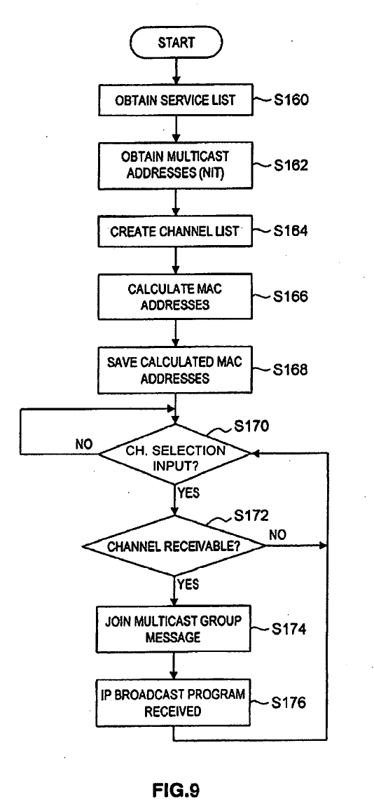

FIG. 9 is a flow chart illustrating the flow of switching channels for content distributed using a multicast network using the reception device 100.

First, the reception device 100 may obtain a service list (step S160). The service list may be obtained from the network information table (NIT) or from the broadcaster information table (BIT) included in the service information (SI) stream.

Next, multicast addresses may be obtained from the service list (step S162). The multicast addresses may be obtained from the NIT included in theSI stream.

A channel list may then be created (step S164). As described above, the channel list may be obtained in advance, thereby allowing convenient and speedy channel selection. The channel list may be, for example, a key station system list or a channel list based on the key station system list; a pay-TV system channel list; a list combining key station system (e.g., digital terrestrial broadcasts or BS digital broadcasts) and pay-TV system channels; a list of regularly viewed channels; and/or or a fixed number of selected channels.

After the channel list is created, the MAC addresses corresponding to the channels on the channel list may be calculated (step S166). The multicast MAC addresses may be calculated by the physical address setting portion 114. After the multicast MAC addresses have been calculated, the calculated MAC addresses may be saved (step S168). The calculated MAC addresses may be saved in the physical address memory portion 112.

Next, it may be determined whether the reception device 100 has received a channel selection input (e.g., a channel number selection) from a remote control or the like (step S170). If it is determined in step S170 that a channel selection has not been input, step S170 is repeated. On the other hand, if it is determined in step S170 that a channel selection has been input, it is then determined whether the channel number is for a receivable channel (step S172). As discussed above, the CAS/DRM client 140 determines whether the reception device 100 can receive a particular channel.

If the CAS/DRM client 140 determines that the channel can be received by the reception device 100, a join message is transmitted to the distribution server 13 to join the multicast group, in order to receive the content from the channel (step S174). Then, the IP broadcast distributed by the distribution server 13 is received, and the content on the channel can be viewed (step S176).

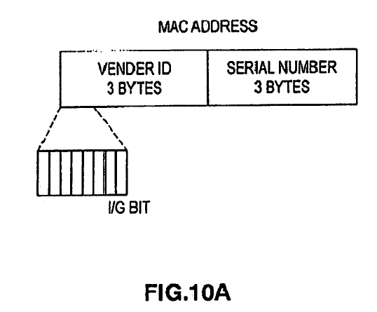

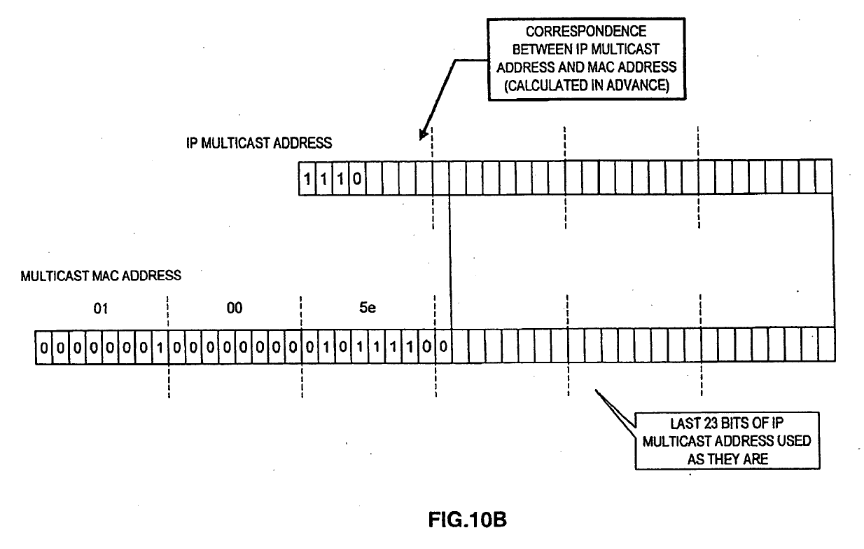

FIG. 10A and FIG. 10B are explanatory diagrams illustrating a MAC address, an IP multicast address, and a multicast MAC address for Internet Protocol Version 4 (IPv4). As shown in FIG. 10a, a MAC address may include 3-byte vendor ID information and 3-byte serial number information. Of the 3 bytes forming the vender ID information, the last bit of the first octet may be an I/G bit identifying whether the address is a unicast or a multicast address. If the I/G bit value is 0, the address may be a unicast address, and if the I/G bit value is 1, the address may be a multicast address.

FIG. 10B is an explanatory diagram explaining an IP multicast address and a multicast MAC address. As shown in FIG. 10B, an IP multicast address may contain 4 bytes (32 bits), and a multicast MAC address may contain 6 bytes. The Institute of Electrical and Electronic Engineers (IEEE) has defined multicast MAC addresses for which the first 25 bits are 0000000100000000010111100 (i.e., the first 3 bytes are 01-00-5e) to be multicast MAC addresses for multicast IP addresses. Therefore, a multicast MAC address for a multicast IP address can be determined by using the last 23 bits of an IP multicast address as contained in the last 23 bits of a multicast MAC address.

In this way, the multicast MAC address determined by the physical address setting portion 114 may be saved to the physical address memory portion 112 before switching channels. By using the multicast MAC address saved in the physical address memory portion 112 for packet filtering when the channel is switched, it may be unnecessary to calculate the multicast MAC address from the multicast IP address at the time the channel is switched, thus reducing the time required for switching the channel.

In an IP broadcast, multicast packets are distributed over a network. In contrast to video on demand (VOD) unicast distribution, it may be necessary for multicast packets to contain a plurality of destination MAC addresses, as the destination multicast MAC address may change with the IP address.

According to the present embodiment, a 48-bit multicast MAC address may be computed using a CRC32 polynomial. The first 6 bits (0-63) may then be used as hash values to pass packets matching the multicast MAC address stored in the physical address memory portion 112, and to discard all other packets. By filtering the packets in this way, the reception device 100 can receive multicast distribution content addressed to the reception device 100.

Further, by using the multicast MAC addresses stored in the physical address memory portion 112 for packet filtering when switching channels, the time required for switching the channel can be reduced by approximately several hundred milliseconds.

The reception device 100 may also have a network interface card (NIC) with a plurality of filters or a complete matched filter. Switching channels during multicast content distribution can be made even quicker by using such an NIC. As explained above with respect to the first embodiment, when switching channels, the multicast MAC addresses for selected channels may be set in advance on the NIC filter, before the switching is performed. By setting the multicast MAC addresses in advance, packet filtering by the NIC filter for the reception device 100 can be reduced, thus reducing the time required to switch channels.

In a second embodiment, reducing the channel switching time will be explained where there are a plurality of reception devices receiving the content within one network segment (e.g., within one household).

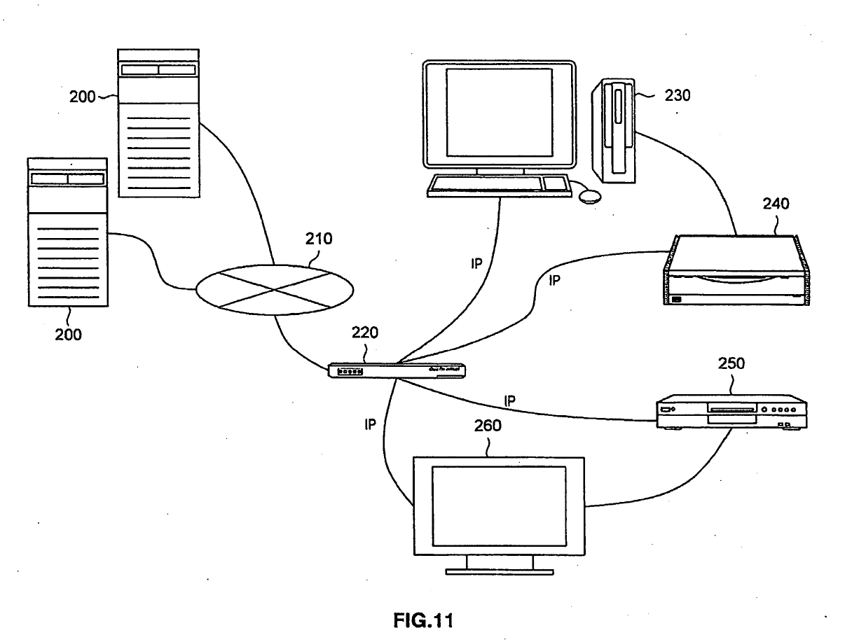

FIG. 11 is an explanatory diagram illustrating a multicast distribution system according to the second embodiment. The multicast distribution system according to the second embodiment will be explained with reference to FIG. 11.

As shown in FIG. 11, the multicast distribution system may include, among other things, a plurality of distribution servers 200, a home gateway (HGW) 220, a personal computer 230, a DVD recorder 240, a hard disk recorder 250, and a television 260.

The distribution servers 200, similar to the distribution server 13 in the first embodiment, may manage the multicast content data for IPTV content and the like, and, in response to a request from a reception device, may distribute the multicast content image and audio media streams to reception devices. The distribution servers 200 may be content-providing servers, such as IPTV servers, broadcasting stations, or the like.

The home gateway 220 may be a network device with a router, protocol conversion and firewall functions, etc., and may relay data passing through the multicast distribution system according to the second embodiment. The home gateway 220 may be connected to the distribution servers 200 by a CDN 210. The CDN 210 may be a network optimized to distribute digital content of large file sizes via the network.

The personal computer 230, the DVD recorder 240, the hard disk recorder 250, and the television 260 are examples of reception devices consistent with the present invention, and each device can receive multicast distribution content via the network. Each device may be connected to the home gateway (HGW) 220 via an Internet Protocol (IP) network to form a home network.

The personal computer 230, the DVD recorder 240, the hard disk recorder 250, and the television 260 may include structure such as that discussed above in connection with the reception device 100, and each device may be able to receive and to play back multicast distributed content.

The multicast distribution system according to the second embodiment has been explained above with reference to FIG. 11. It is to be appreciated, however, that the configuration shown in FIG. 11 is only one example of the second embodiment. Other embodiments are possible. For example, package routing may be performed by providing an edge router between the CDN 210 and the home gateway 220.

Next, channel switching in the multicast distribution system according to the second embodiment will be explained.

First, in the same way as in the first embodiment, the multicast MAC addresses for the selected channels may be set on the NIC of each reception device. As in the first embodiment, a list of selected channels may be utilized, such as, for example, a key station system list or a channel list based on the key station system list (e.g., digital terrestrial broadcasts, BS digital broadcasts, or a combination thereof); a pay-TV system channel list (e.g., channels subscribed to by a viewer, channels recommended by a provider, or a combination thereof); a list combining key station system (e.g., digital terrestrial broadcasts or BS digital broadcasts) and pay-TV system channels (e.g., preferred channels registered in advance by a user); and/or a channel list of regularly-viewed channels (e.g., recently viewed channels within the maximum number of channels that can be set on the NIC filter, or a fixed number of selected channels).

Next, when switching channels on each reception device, it may first be checked on the NIC of each device whether the multicast stream for the channel being switched to is currently passing through the home network (i.e., patting to another reception device on the same home network), separately from the multicast streams currently being received by the respective reception device.

During this check, if the NIC of any of the reception devices detects that the multicast stream of the channel to be switched to is passing through the home network, decoding of the multicast stream may be started. Then, a join message to join the next multicast stream may be issued to the home gateway 220, and a leave message may be issued to the home gateway 220 to leave the multicast stream being received up to that point in time (i.e., the previous channel).

For example, if a program on channel A is being distributed to the personal computer 230 and a program on channel B is being distributed to the DVD recorder 240, the multicast streams for both channel A and channel B may be passing through the home network. When the channel being received by the personal computer 230 is switched from channel A to channel B, it may be determined that the multicast stream for channel B is already passing through the home network (i.e., to the DVD recorder 240).

Therefore, in this case, the personal computer 230 may start decoding the multicast stream for channel B. The personal computer 230 may then issue a join request to the home gateway 220 to join channel B multicast stream, and issue a leave request to the home gateway 220 to leave channel A multicast stream, which was being received up to that point in time.

In this way, before issuing a request to the home gateway 220 to join the next multicast stream, decoding of the next multicast stream may be started in advance, thus reducing the time required to switch the channel.

As explained above, in the second embodiment, when switching channels, the multicast MAC addresses for the content on selected channels distributed by the distribution server may be set on an NIC filter. Then, it may be checked on the NIC filter whether another multicast stream is passing through the home network. If the multicast stream is detected, decoding of the stream may be started in advance of switching to the channel, thus providing for quicker channel switching.

By incorporating a computer program to realize the functions according to the embodiments described above, the computer may be caused to function as the reception device 100 or any other devices associated with the multicast distribution system 10. The computer program can be stored on a computer-readable storage medium, such as optical storage, magnetic storage, solid state storage, a CD, a DVD, a hard drive, RAM, ROM, a flash drive, and/or any other suitable computer-readable storage medium.

It will be apparent to those skilled in the art that various modifications and variations can be made to the present invention. Other embodiments of the present invention will be apparent to those skilled in the art from consideration of the specification and practice of the invention. It is intended that the specification and examples be considered as exemplary only, with a true scope of the invention being indicated by the following claims and their equivalents.

What is claimed is:

1. A reception device for receiving content on channels distributed by distribution servers via a router, the reception device comprising:
a memory storing:
a physical address setting portion that registers a multicast media access control address of a channel to be switched to before switching the channel,
a physical address memory portion that stores the multicast media access control address, and
a channel switching portion that uses the stored multicast media access control address to switch to the channel; and
a processor that executes the physical address setting portion, the physical address memory portion, and the channel switching portion.

2. The reception device according to claim 1, wherein the physical address setting portion receives the multicast media access control address from a multicast address contained in a service information stream.

3. The reception device according to claim 2, wherein a portion of the multicast media access control address is the same as a portion of the multicast address contained in the service information stream.

4. The reception device according to claim 1, wherein the channel switching portion checks whether the channel is being carried by a network segment that the reception device is on before switching to the channel.

5. The reception device according to claim 4, wherein the network segment is a local network.

6. The reception device according to claim 4, further comprising:
a decoding portion that decodes the content on the channels for presentation; and
a message issuing portion that sends a message to the distribution servers or to the router, wherein
if the channel is being carried by the network segment, the decoding portion starts decoding the content on the channel before a Join message or a Leave message is sent by the message issuing portion.

7. A method for receiving, by a reception device, content on channels distributed by distribution servers via a router, the method comprising:
registering a multicast media access control address corresponding to a channel to be switched to before switching to the channel;
storing the multicast media access control address; and
switching to the channel using the stored multicast media access control address.

8. The method of claim 7, wherein the multicast media access control address is received from a multicast address contained in a service information stream.

9. The method of claim 8, wherein a portion of the multicast media access control address is the same as a portion of the multicast address contained in the service information stream.

10. The method of claim 7, further comprising checking whether the channel is being carried by a network segment that the reception device is on before switching to the channel.

11. The method of claim 10, wherein the network segment is a local network.

12. The method of claim 10, further comprising:
sending a message to the distribution servers or to the router; and
starting decoding of the content on the channel before a Join message or a Leave message is sent if the channel is being carried by the network segment.

13. A reception device for receiving content on channels distributed by distribution servers via a router, the reception device comprising:
means for registering a multicast media access control address of a channel to be switched to before switching the channel;
means for storing the multicast media access control address; and
means for using the stored multicast media access control address to switch to the channel.

14. The reception device according to claim 13, wherein the means for registering receives the multicast media access control address from a multicast address contained in a service information stream.

15. The reception device according to claim 14, wherein a portion of the multicast media access control address is the same as a portion of the multicast address contained in the service information stream.

16. The reception device according to claim 13, wherein the means for switching the channel checks whether the channel is being carried by a network segment that the reception device is on before switching to the channel.

17. The reception device according to claim 16, wherein the network segment is a local network.

18. The reception device according to claim 16, further comprising:
means for decoding the content on the channels for presentation; and
means for issuing a message the distribution servers or to the router, wherein
if the channel is being carried by the network segment, the means for decoding starts decoding the content on the channel before a Join message or a Leave message is sent by the means for issuing a message.

19. A computer-readable medium storing a computer program which, when executed by a computer, causes the computer to perform a method of receiving content on channels distributed by distribution servers via a router, the method comprising:
registering a multicast media access control address corresponding to a channel to be switched to before switching to the channel;
storing the multicast media access control address; and
switching to the channel using the stored multicast media access control address.
